(19) United States
(12) Patent Application Publication
(10) Pub. No.: US 2017/0041321 A1
(43) Pub. Date: Feb. 9, 2017

(54) METHOD AND SYSTEM FOR PROVIDING ROOT DOMAIN NAME RESOLUTION SERVICE

(71) Applicants: BEIJING QIHOO TECHNOLOGY COMPANY LIMITED, Beijing (CN); QIZHI SOFTWARE (BEIJING) COMPANY LIMITED, Beijing (CN)

(72) Inventors: Xiaosheng TAN, Beijing (CN); Xiangdong QI, Beijing (CN); Can PU, Beijing (CN)

(73) Assignee: Beijing Qihoo Technology Company Limited, Beijing (CN)

(21) Appl. No.: 15/305,094

(22) PCT Filed: Mar. 19, 2015
(86) PCT No.: PCT/CN2015/074613

§ 371 Date: Oct. 18, 2016

(30) Foreign Application Priority Data
Apr. 18, 2014 (CN) 201410158694.1

(51) Int. Cl. H04L 29/06; H04L 29/12

(52) U.S. Cl. CPC H04L 63/10; H04L 61/1511

(57) ABSTRACT

Disclosed are method and system for providing root domain name resolution service, wherein the method for providing root domain name resolution service comprises: acquiring DNS resolution records of domain names within a predefined region; establishing an authorization information database of all-level nodes of DNS according to the resolution record; initiating a virtual root node providing root domain name resolution service; and responding to a root domain name resolution request within the predefined region according to data in the authorization information database by the virtual root node. The scheme of the present invention can utilize the DNS resolution records within the predefined region, to establish a DNS authorization information database as a data foundation of the virtual root node providing root domain name resolution service, thereby automatically providing DNS root resolution service within the region and reducing an Internet risk.

### CROSS-REFERENCE TO RELATED APPLICATIONS

This application is the national stage of International Application No. PCT/CN2015/074613 filed Mar. 19, 2015, which claims the benefit of Chinese Patent Application No. CN201410158694.1, filed Apr. 18, 2014, the entirety of which are incorporated herein by reference.

### FIELD OF TECHNOLOGY

The present invention relates the field of communication technologies, and in particular, to a method and system for providing root domain name resolution service.

### BACKGROUND

A DNS, an abbreviation of Domain Name System, is a core service of Internet. As a distributed database that can mutually map a domain name with IP address, the DNS can make it more convenient for a user to access to Internet without bearing in mind IP strings that can be read directly by a machine.

Usually, an Internet host domain name has a general structure as follows: host name. third-level domain name. second-level domain name. top-level domain name. The top-level domain name of Internet is registered and searched by an Internet network association, and is enrolled and managed by a committee responsible for network address allocation. A unique IP address is allocated for each host on the Internet.

FIG. 1 is a hierarchical architecture diagram of DNS in the prior art. The existing DNS architecture is a hierarchical tree structure which is referred to as a DNS domain name space. An uppermost domain name space is referred to as “root node”. A path from a top-level domain to a sub-domain forms a domain name. For example, a path from a top-level domain.com to its second-level domain Microsoft and then to a sub-domain departmentA of Microsoft forms a domain name of departmentA.microsoft.com.

FIG. 2 is a domain name resolution flow for DNS in the prior art. Introduction will be provided by way of resolution processes of access to NetEase portal address www.163.com, for example. The processes thereof are as follows:

Step 1, a user's computer may send a resolution request for www.163.com to a local DNS server provided on its system. The so-called local DNS server refers to a IP address of DNS service which could be automatically acquired from an operator or could be manually setup.

Step 2, the local DNS server may examine the presence of a cache of the domain name within its own space; if absence, it may send the domain name resolution request for www.163.com to a root server.

Step 3, after receiving the resolution request of the local DNS server regarding domain name, the root server may analyze the requested domain name and return a IP address of a server of the domain name node.com to the local server.

Step 4, after receiving the server IP address of top-level domain.com, the local DNS server may send a query of the resolution request for www.163.com to the top-level domain.com.

Step 5, after receiving the resolution request regarding www.163.com, a server of top-level domain.com may return a IP address of a DNS server of the second-level domain 163 to the local DNS server.

Step 6, the local DNS server may continue to initiate the resolution request regarding www.163.com to the DNS server of the second-level domain 163.

Step 7, a management server of the domain 163 may manage all sub-domain name under 163.com. Its domain name space contains a sub-domain name www, a corresponding IP address of which is 111.1.53.220. Therefore, the DNS server of 163.com domain may return the IP address 111.1.53.220 corresponding to www.163.com to the local DNS server.

Step 8, after receiving a resolution result regarding www.163.com from the domain server of 163.com, the local DNS server may return the corresponding IP address 111.1.53.220 to the user while keeping the result for a period of time for other users' queries.

Step 9, after acquiring the IP address 111.1.53.220 corresponding to domain name www.163.com, the user's computer may start to request for web contents from IP 111.1.53.220. Hereto, a flow of a complete resolution request of DNS is over.

DNS root server is a “root” of a DNS tree domain name space, responsible for the resolution of TLD (top Level Domain) and playing a very important role in the domain name resolution. In theory, if there is a need to resolve a standard domain name in any forms, according to the technique processes, operations of global “hierarchical” domain name resolution system are necessarily required to undergo.

As could be seen from above introduction, the first layer of the “hierarchical” domain name resolution system is the root server, responsible for the management of domain name information of various countries in the world; the top-level domain name server is just under the root server, which is a database of a domain name management organization of a relevant country, such as CNNIC in China; and then a query can be made in a caching server of next level domain name database and ISP (Internet Service Provider). Only when a domain name is firstly subjected to a resolution of root database, it could be transferred to the top-level domain name server for resolution. If the DNS root node cannot be visited, then all of the domain name resolutions will fail.

However, there are only 13 root servers all over the world. The distribution condition at present is as follows: one main root server (A) in US, nine auxiliary root servers (B-M) in US, and one auxiliary root server in Sweden, Netherlands and Japan, respectively. In the prior art, if domain names in a certain region are shield in the resolution system, their IP addresses could not be resolved. Then websites directed by these domain names would disappear on the Internet. In the prior art, therefore, there is no solution scheme to cope with the root domain name resolution failure within a region.

### SUMMARY

In the view of above problems, the present invention is proposed to provide a system for providing root domain name resolution service and a corresponding method for providing root domain name resolution service, to overcome or at least partially resolve or relieve above problems.

According to one aspect of the present invention, there is provided a method for providing root domain name resolution service, which comprises steps of: acquiring DNS resolution records of domain names within a predefined region; establishing an authorization information database of all-level nodes of DNS according to the resolution record; initiating a virtual root node providing root domain name resolution service; and responding to a root domain name resolution request within the predefined region according to data in the authorization information database by the virtual root node.

According to another aspect of the present invention, there is provide a system for providing root domain name resolution service, which comprises: a data acquisition device, configured to acquire DNS resolution records of domain names within a predefined region; and a virtual root node server, configured to establish an authorization information database of all-level nodes of DNS according to the resolution record and operate with a virtual root node providing the root domain name resolution service to respond to a root domain name resolution request within the predefined region according to data in the authorization information database.

According to still another aspect of the present invention, there is provided a computer program, comprising computer readable codes, which causes an electronic device to perform the method for providing root domain name resolution service above, when said computer-readable code is running on the electronic device.

According to still yet another aspect of the present invention, there is provided a computer readable medium, in which the above-mentioned computer program is stored.

Advantageous effects of the present invention are as below.

The method and system for providing root domain name resolution service according to the present invention can utilize the DNS resolution records within the predefined region, to establish a DNS authorization information database as a data foundation of the virtual root node providing root domain name resolution service, thereby automatically providing DNS root resolution service within the region and reducing an Internet risk due to a domain name resolution failure within the region when the existing DNS system dominates the root domain name resolution.

Further, in the method and system for providing root domain name resolution service according to the present invention, the virtual root nodes are disposed in a distributed manner; by externally providing services in the anycast mode, it is possible to reduce a single point failure of DNS and improve a defense capacity against DNS attacks, while configuring a visit authority control for the virtual root node and shielding attack data of DNS; and a normal response of the local DNS within the region can be preferentially ensured.

Described above is merely an overview of the inventive scheme. In order to more apparently understand the technical means of the present invention to implement in accordance with the contents of specification, and to more readily understand above and other objectives, features and advantages of the present invention, specific embodiments of the present invention are provided hereinafter.

### BRIEF DESCRIPTION OF THE DRAWINGS

Through reading the detailed description of the following preferred embodiments, various other advantages and benefits will become apparent to those of ordinary skills in the art. Accompanying drawings are merely included for the purpose of illustrating the preferred embodiments and should not be considered as limiting of the present invention. Further, throughout the drawings, like reference signs are used to denote like elements.

FIG. 1 is a hierarchical architecture diagram of DNS in the prior art.

FIG. 2 is a domain name resolution flow for DNS in the prior art.

FIG. 3 is an architecture diagram illustrating a system for providing root domain name resolution service according to an embodiment of the present invention.

FIG. 4 is a schematic diagram in which the system for providing root domain name resolution service grabs data packets at an outlet of backbone network to acquire data according to an embodiment of the present invention.

FIG. 5 is a schematic diagram in which the system for providing root domain name resolution service uses a local DNS server to acquire data according to an embodiment of the present invention.

FIG. 6 is a schematic diagram in which the system for providing root domain name resolution service provides root domain name resolution service according to an embodiment of the present invention.

FIG. 7 is a schematic diagram of a method for providing root domain name resolution service according to an embodiment of the present invention.

FIG. 8 schematically illustrates a block diagram of a computing device for carrying out the method for providing root domain name resolution service according to the present invention.

FIG. 9 schematically illustrates a memory cell which is used to store or carry program codes for realizing the method for providing root domain name resolution service according to the present invention.

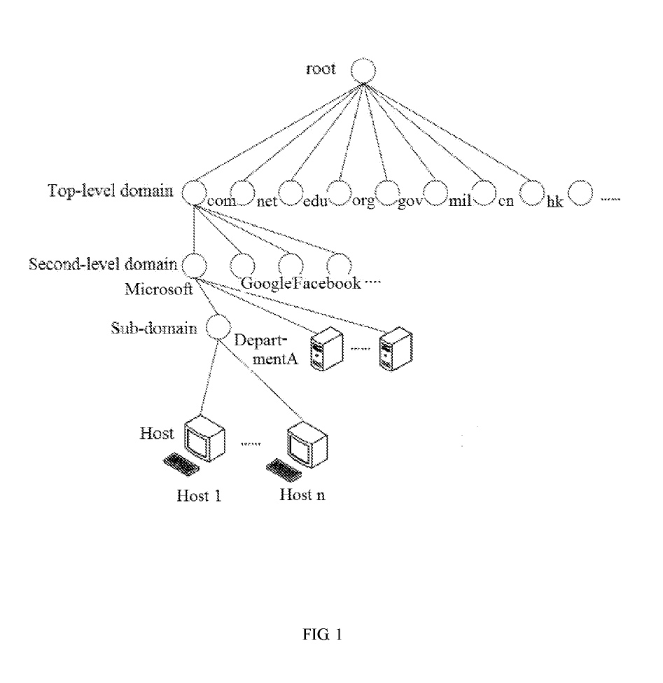

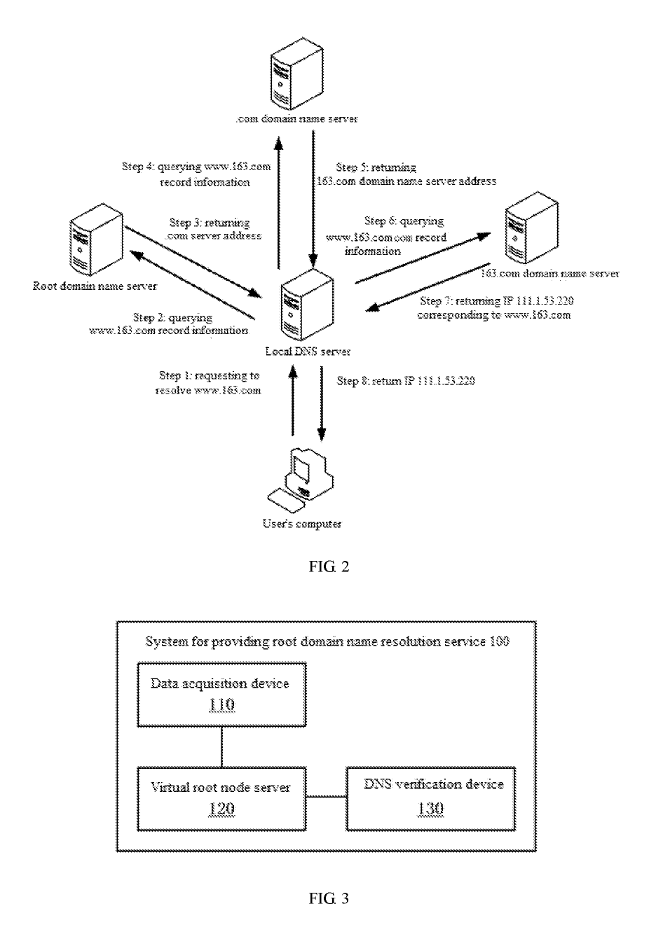

### DESCRIPTION OF THE EMBODIMENTS

The present invention will be further described in detail in conjunction with accompanying figures and specific embodiments.

FIG. 3 is an architecture diagram illustrating a system for providing root domain name resolution service 100 according to an embodiment of the present invention. Generally, the system for providing root domain name resolution service 100 may comprise: a data acquisition device 110 and a virtual root node server 120 and may further provided with a DNS verification device 130.

In an embodiment of the present invention, the data acquisition device 110 is configured to acquire DNS resolution records of domain names within a predefined region. The virtual root node server 120 is configured to establish an authorization information database of all-level nodes of DNS according to the resolution record and operate with a virtual root node providing the root domain name resolution service to respond to a root domain name resolution request within the predefined region according to data in the authorization information database. The DNS verification device 130 is configured to determine whether a resolution result of DNS is correct; in the case that the determining result of the DNS verification device is negative, the virtual root node server 120 may initiate the virtual root node providing root domain name resolution service.

In this embodiment, the system of root domain name resolution service 100 can utilize the DNS resolution records within the predefined region, to establish a DNS authorization information database as a data foundation of the virtual root node providing root domain name resolution service, thereby automatically providing DNS root resolution service within the region and reducing an Internet risk due to a domain name resolution failure within the region when the existing DNS system dominates the root domain name resolution. For example, Chinese territory may be regarded as above predefined region. In the process of cn domain name resolution, DNS resolution records of all cn domain names can be acquired and an authorization information database of the en domain names can be established, such that when the existing DNS system refuses to provide the root resolution service of the cn domain names, or when the root resolution service of the cn domain names fails, the virtual root node of the system of root domain name resolution service 100 in this embodiment can utilize the backup data to provide the cn domain name resolution service.

The data acquisition device 110 can acquire the DNS resolution records in various manners. For example, in an optional manner, DNS resolution data packets are grabbed at an outlet of backbone network within a predefined region; and the DNS resolution data packets are analyzed to acquire all-level DNS resolution records of the resolved domain name. In another optional manner, in the process of domain name recursive resolution of a local recursive DNS, information of all-level authorization servers of the resolved domain name is acquired; and the information of all-level authorization servers of the resolved domain name is saved as the DNS resolution records of domain names.

In the first manner as stated above, when a DNS resolution requests is made to a root domain name resolution server outside the region, it is necessary to pass through a local backbone network router. Therefore, the DNS resolution data packets can be grabbed at the outlet of the backbone network to acquire the DNS resolution records.

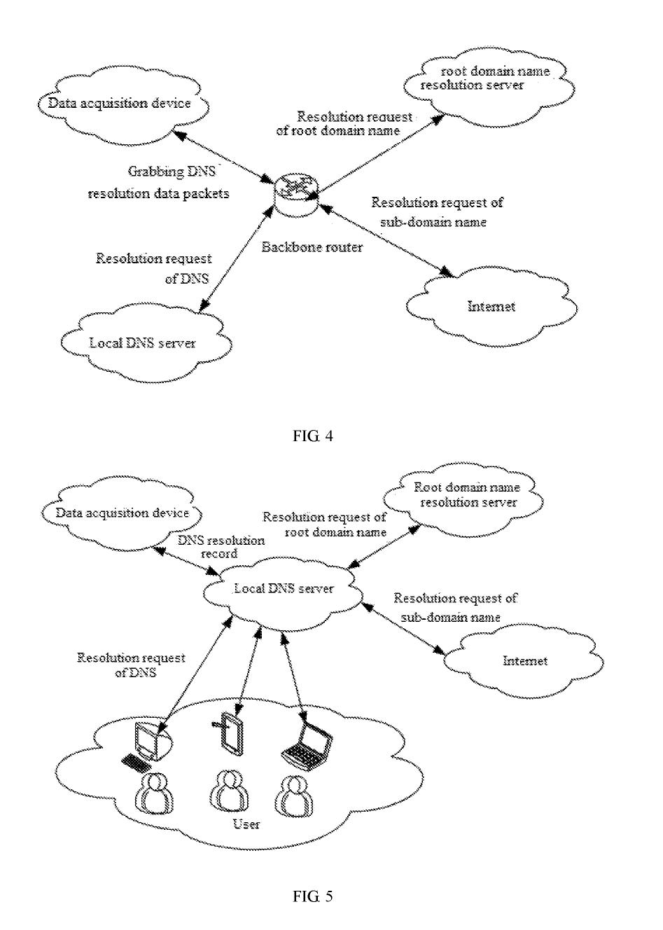

FIG. 4 is a schematic diagram in which the system for providing root domain name resolution service 100 grabs data packets at an outlet of backbone network to acquire data according to an embodiment of the present invention. The root domain name resolution server may create a mirror site by anycast technologies, but it is necessary to rely on the root domain name resolution server. In this embodiment, by the process of layer-by-layer resolution of the DNS protocol itself or by grabbing and analyzing pockets at the outlet of backbone network, the desirable authorization information of DNS resolution can also be collected to establish a relatively complete hierarchical relation of DNS, and then to establish perfect data required by the virtual root node.

In the second manner as stated above, the user host sends the DNS resolution request to the local DNS generally by a recursive query. When the local DNS server does buffer an address of the queried domain name, the local DNS server may still send a query request message to other root domain name servers and acquire results. The data acquisition device 110 may utilize the process of the domain name recursive resolution of the local recursive DNS to acquire information of next level of authorization server in the all-level DNS authorization servers, thereby acquiring the information of the all-level authorization servers.

FIG. 5 is a schematic diagram in which the system for providing root domain name resolution service 100 uses a local DNS server to acquire data according to an embodiment of the present invention. In the hierarchical relation and distributed structure of DNS (Domain Name System), each level of node in a hierarchical space may store an authorization information record of next level of relevant node. In the process of the layer-by-layer resolution, the local DNS may access to all-level nodes in the domain name space. Therefore, it is possible to utilize the recursive process of the local DNS server to store these authorization records of the node information. On the basis of the relationship of the records, a backup domain name hierarchy space may be formed to establish a authorization information database. The authorization database corresponds to each level of the domain name space, and the data information is updated in real time such that the authorization information database forms a mirror of Internet domain name hierarchy. Since the database possesses the whole authorization information records, it is possible to utilize the data in this database to realize an authorization resolution service of DNS server at this level when the root node or even any one level of domain name node server fails.

In recursion, the local recursive DNS server (a DNS provided by an inflow operator and a public DNS) may acquire information of the all-level authorization server corresponding to the domain name. Therefore, during the recursion of the local DNS, the resolution records corresponding to all the domain names within the region can be mirrored to form a backup storage.

A plurality of virtual root node servers 120 may be provided in a distributed manner, and be further configured to save the authorization information database in accordance with a type of domain name and to provide a data service in accordance with BGP (Border Gateway Protocol). BGP is a routing protocol of autonomous system operating on TCP. BGP is used to handle protocols of network such as a size of Internet, and also can duly handle protocols of multiple links between irrelevant routing domains. The plurality of virtual root node servers 120 may share one address to provide data service in an Anycast form. By the Anycast, when a unicast address is allocated to more than one interfaces, a message sent to the interface is routed on the network to a “nestest” target interface measured by the routing protocol. The Anycast allows the DNS resolution request to send the data packets to one node in the plurality of virtual root node servers 120. This node is selected by the routing system and is clear to the request-party node, so as to provide a better service for the source node to a certain degree while relieving network load.

With the architecture of the distributed database system, the plurality of virtual root node servers 120 may acquire a corresponding response result by querying the distributed database. By an OSPF (Open Shortest Path First) protocol, multiple machines can operate at the same time to improve the response capacity. The OSPF protocol is an IGP (Interior Gateway Protocol) for making a decision of routing in a single autonomous system (AS), which is an implementation of link status routing protocol and which pertains to the IGP operating in the autonomous system.

In addition, the disposition of the virtual root node servers 120 in the distributed manner not only may speed up the process of resolving DNS, but also may more appropriately make use of Internet resource. Further, by externally providing services in the anycast mode, it is possible to reduce a single point failure of DNS and improve a defense capacity against DNS attacks, while configuring a visit authority control for the virtual root node and shielding attack data of DNS. When a resolution abnormity occurs, a normal response of the local DNS server within the region can be preferentially ensured.

An operational process of the DNS verification device 130 is as follows: monitoring a DNS resolution message at the outlet of the backbone network within the predefined region; determining whether the DNS resolution message is received and whether the DNS resolution message is matched with pre-stored results; if any one of results is determined to be negative, then determining that the resolution result of DNS is not correct. In the case of the root domain name resolution failure, the virtual root node server 120 can provide the virtual root node for the root domain name resolution service to complete the operation of the root domain name resolution in the predefined region.

Generally, the result of the root domain name resolution cannot be easily modified. If the currently returned resolution result is not matched with the pre-stored result in a historic record, then it may be proved that the resolution has been modified. A warning or manual intervention is needed. In addition, if an authorization of a top-level domain could not normally operate or all return a “SERVFAIL”, the resolution result may be directly determined to be not correct. A method for handling incorrect resolution result of DNS would be as follows: after the resolution result is modified, making a judgment according to warning information, clicking an operating interface, automatically switching in bulk to the DNS resolution of virtual root node by the system.

Above warning information can be determined in combination of pre-collected illegal DNS IP address list and legal DNS IP address white list. For example, pre-collected malicious DNS IP address list could be a set of illegal DNS IP addresses pre-collected by a security-software vendor. The pre-collected malicious DNS IP address list could be a pre-collected malicious DNS IP address list in a client database or a malicious DNS IP address list downloaded from a website to the client database. The preset legal DNS IP address white list could be pre-stored in the client database or downloaded from a server of website (for example, cloud security server).

In a specific implementation, security levels may substantially comprise “dangerous”, “warning” and “safe”, wherein the security level of the “dangerous” means a maximum threat to the user, the “warning” takes the second place and the “safe” is weakest. Prompts on an interface could also be provided according thereto. After interface warning information occurs on the interface, the virtual root node could be automatically or manually initiated to avoid a security risk due to the illegal resolution result of DNS.

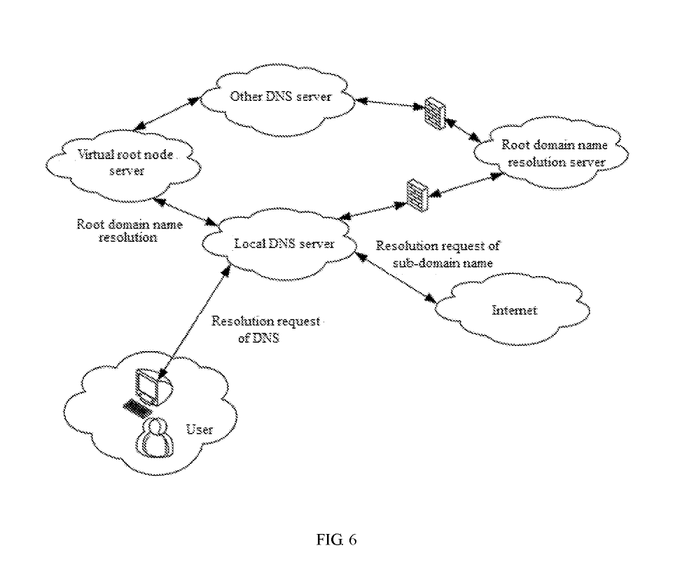

FIG. 6 is a schematic diagram in which system for providing root domain name resolution service 100 provides root domain name resolution service according to an embodiment of the present invention. After the data acquisition device 110 has established the domain name authorization information database, the virtual root node server 120 could initiate a virtual root node service on the basis of data, externally providing the resolution service and other top-level domain authorization disaster-backup service as the root node.

In the meanwhile, on the backbone network, a DNS data message starts to be monitored at an outlet outside the region, to monitor a validity of the DNS resolution record. Once abnormities of root node and other uncontrolled domain name resolution are found, a corresponding request pocket could be sent to the virtual root node at the outlet for a resolution response, avoiding that the data subsequently is transferred to an overseas server to lead to modification. Any one of domain names is necessarily acquired from the root node. If the root node returns an error, it may result in resolution abnormities of all the domain names and directly lead to a whole Internet abnormity. By the system for providing root domain name resolution service 100 according to this embodiment, the similar security risk could be efficiently avoided.

In the case where the existing root domain name resolution server or other corresponding domain name resolution shows an exception, the virtual root node server 120 may utilize the authorization information database to establish the virtual root node in the BGP manner (anycast mode) to externally provide DNS resolution service.

For other recursive DNS, by modifying the root node IP to point to a virtual root service IP or forwarding all the domain name resolutions to the virtual root node, the virtual root node may provide the domain name resolution service on the basis of the authorization information database. When other DNS service provider cannot repair rapidly, the user host who sent the DNS resolution request may emergently repair the user's DNS to resolvable public DNS, to ensure that the network user can normally use the network.

Above virtual root node server 120 may further determine and handle whether the DNS resolution request is malicious by determining the information of the DNS resolution request, to defend against a denial-of-service attack of the DNS. For example, the virtual root node server 120 may realize a high-speed and safe resolution of DNS request for example by using cache, cache access optimization and pre-updating to reduce resolution delay as far as possible. When a flow amount of a request source abnormally sharply increases, a speed of the DNS resolution request source may be limited by automatic analysis and security interaction.

For example, in this embodiment, the virtual root node server 120 may perform the domain name resolution on the DNS resolution request sent from the local DNS. The virtual root node server 120 is provided with a defense device against DNS attacks. The defense device may acquire IP addresses of a DNS query request and a request source of the DNS query request; query a visit record database according to the IP addresses to acquire request record information of the request source; determine whether a number of requests in the request record information within a predefined period exceeds a predefined threshold; if yes, then determine that the request source is subjected to DNS attacks and defend. The defense method may provide security protection and prompt by using direct filtration of the DNS request with over-speed or in combination of software such as Safeguard installed in a user's client. For example, the user's client may output a prompt message on a security advice display area, or modify the DNS server address to a predefined safe address, thereby improving the security of the virtual root node server 120.

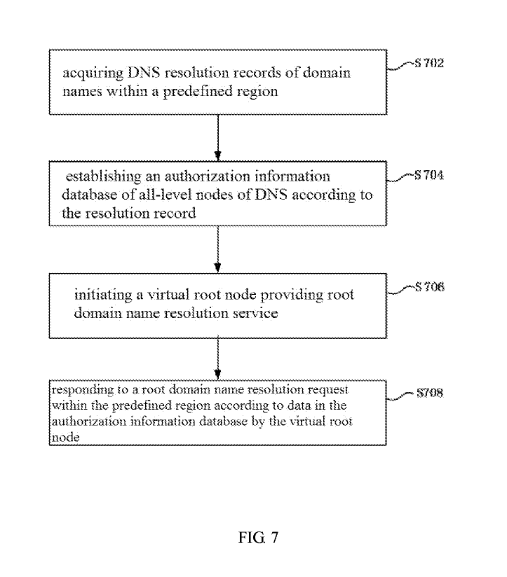

In an embodiment of the present invention, there is also provided a method for providing root domain name resolution service. The method for providing root domain name resolution service can be implemented by any one of the systems for providing root domain name resolution service as explained in aforesaid embodiments, to realize the DNS root domain name resolution within the predefined region. FIG. 7 is a schematic diagram of a method for providing root domain name resolution service according to an embodiment of the present invention. The method for providing root domain name resolution service may comprise steps as below.

Step S702, acquiring DNS resolution records of domain names within a predefined region.

Step S704, establishing an authorization information database of all-level nodes of DNS according to the resolution record.

Step S706, initiating a virtual root node providing root domain name resolution service.

Step S708, responding to a root domain name resolution request within the predefined region according to data in the authorization information database by the virtual root node.

Herein, in an optional flow of S702, DNS resolution data packets are grabbed at an outlet of backbone network within a predefined region; and the DNS resolution data packets are analyzed to acquire all-level DNS resolution records of the resolved domain name.

In another optional flow of Step S702, in the process of domain name recursive resolution of a local recursive DNS, information of next level of authorization server in the all-level DNS authorization servers is acquired; and the required information of the all-level authorization servers is saved as the DNS resolution records of the domain names.

In another optional flow of Step S704, the resolution records are saved as the authorization information database in a distributed manner in accordance with a type of domain name wherein the authorization information database provides a data service in accordance with BGP.

In an optional embodiment of the present invention, prior to Step S708, the method may further comprise: determining whether the DNS resolution result is correct; if the determining result is negative, then going to Step S708 to initiate the virtual root node providing root domain name resolution service. Determining whether the DNS resolution result is correct could be achieved by monitoring a DNS resolution message at the outlet of the backbone network within the predefined region; determining whether the DNS resolution message is received and whether the DNS resolution message is matched with pre-stored results; and if any one of results is determined to be negative, then determining that the resolution result of DNS is not correct.

The scheme in this embodiment can utilize the DNS resolution records within the predefined region, to establish a DNS authorization information database as a data foundation of the virtual root node providing root domain name resolution service, thereby automatically providing DNS root resolution service within the region and reducing an Internet risk due to a domain name resolution failure within the region when the existing DNS system dominates the root domain name resolution.

Many details are discussed in the specification provided herein. However, it should be understood that the embodiments of the present invention can be implemented without these specific details. In some examples, the well-known methods, structures and technologies are not shown in detail so as to avoid an unclear understanding of the description.

Similarly, it should be understood that, in order to simplify the present invention and to facilitate the understanding of one or more of various aspects thereof, in the above description of the exemplary embodiments of the present invention, various features of the present invention may sometimes be grouped together into a single embodiment, accompanying figure or description thereof However, the method of the present invention should not be constructed as follows: the present invention for which the protection is sought claims more features than those explicitly disclosed in each of claims. More specifically, as reflected in the following claims, the inventive aspect is in that the features therein are less than all features of a single embodiment as disclosed above. Therefore, claims following specific embodiments are definitely incorporated into the specific embodiments, wherein each of claims can be considered as a separate embodiment of the present invention.

It should be understood by those skilled in the art that modules of the apparatus in the embodiments can be adaptively modified and arranged in one or more apparatuses different from the embodiment. Modules in the embodiment can be combined into one module, unit or component, and also can be divided into more sub-modules, sub-units or sub-components. Except that at least some of features and/or processes or modules are mutually exclusive, various combinations can be used to combine all the features disclosed in specification (including appended claims, abstract and accompanying figures) and all the processes or units of any methods or devices as disclosed herein. Unless otherwise definitely stated, each of features disclosed in specification (including appended claims, abstract and accompanying figures) may be taken place with an alternative feature having same, equivalent or similar purpose.

In addition, it should be understood by those skilled in the art, although some embodiments as discussed herein comprise some features included in other embodiment rather than other feature, combination of features in different embodiment means that the combination is within a scope of the present invention and forms the different embodiment. For example, in the appended claims, any one of the embodiments for which the protection is sought can be used in any combined manners.

Each of components according to the embodiments of the present invention can be implemented by hardware, or implemented by software modules operating on one or more processors, or implemented by the combination thereof A person skilled in the art should understand that, in practice, a microprocessor or a digital signal processor (DSP) may be used to realize some or all of the functions of some or all of the components in the devices for loading recommendation information, detecting web address and loading recommendation information of search result according to the embodiments of the present invention. The present invention may further be implemented as device program (for example, computer program and computer program product) for executing some or all of the methods as described herein. Such program for implementing the present invention may be stored in the computer readable medium, or have a form of one or more signals. Such a signal may be downloaded from the Internet websites, or be provided in carrier, or be provided in other manners.

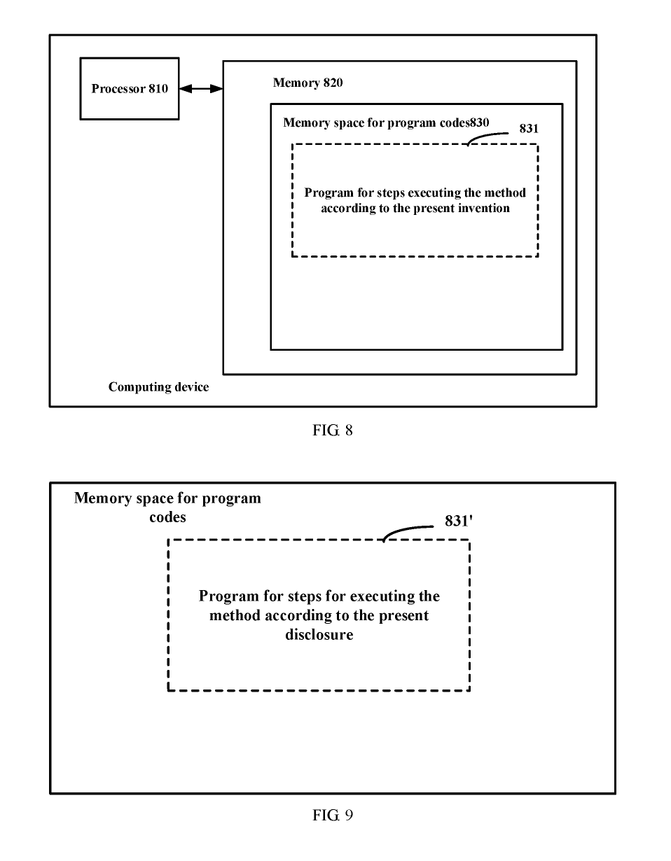

For example, FIG. 8 is a computing device which may implement the method for providing root domain name resolution service according to the present invention. Traditionally, the computing device includes a processor 810 and a computer program product or a computer readable medium in the form of a memory 820. The memory 820 could be electronic memories such as flash memory, EEPROM (Electrically Erasable Programmable Read-Only Memory), EPROM, hard disk or ROM. The memory 820 has a memory space 830 for program codes 831 executing any steps in the above methods. For example, the memory space 830 for program codes may include program codes 831 for implementing the respective steps in the method as mentioned above. These program codes may be read from or be written into one or more computer program products. These computer program products include program code carriers such as hard disk, compact disk (CD), memory card or floppy disk. These computer program products are usually the portable or stable memory cells as shown in FIG. 9. The memory cells may be provided with memory sections, memory spaces, etc., similar to the memory 820 of the electronic device as shown in FIG. 8. The program codes may be compressed for example in an appropriate form. Usually, the memory cell includes computer readable codes 831′ which could be readable for example by the processor 810. When these codes are operated on the computing device, the computing device may execute respective steps in the method as described above.

The “an embodiment”, “embodiments” or “one or more embodiments” mentioned in the present invention means that the specific features, structures or performances described in combination with the embodiment(s) would be included in at least one embodiment of the present invention. Moreover, it should be noted that, the wording “in an embodiment” herein may not necessarily refer to the same embodiment.

It should be noted that the above-described embodiments are intended to illustrate but not to limit the present invention, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The present invention may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the present invention. Therefore, it is obvious for an ordinary skilled person in the art that modifications and variations could be made without departing from the scope and spirit of the claims as appended. For the scope of the present invention, the publication of the inventive disclosure is illustrative rather than restrictive, and the scope of the present invention is defined by the appended claims.

1. A method for providing root domain name resolution service, comprising steps of:
acquiring DNS resolution records of domain names within a predefined region;
establishing an authorization information database of all-level nodes of DNS according to the resolution record;
initiating a virtual root node providing root domain name resolution service; and responding to a root domain name resolution request within the predefined region according to data in the authorization information database by the virtual root node.

2. The method according to claim 1, wherein the step of acquiring DNS resolution records of domain names within a predefined region comprises:
grabbing DNS resolution data packets at an outlet of backbone network within a predefined region; and
analyzing the DNS resolution data packets to acquire all-level DNS resolution records of the resolved domain name.

3. The method according to claim 1, wherein the step of acquiring DNS resolution records of domain names within a predefined region comprises:
in the process of domain name recursive resolution of a local recursive DNS, acquiring information of next level of authorization server in the all-level DNS authorization servers; and
saving the acquired information of all-level authorization servers as the DNS resolution records of the domain names.

4. The method according to claim 1, wherein
the step of establishing an authorization information database of all-level nodes of DNS according to the resolution record comprises:
saving the resolution records as the authorization information database in a distributed manner in accordance with a type of domain name wherein the authorization information database provides a data service in accordance with BGP.

5. The method according to claim 1, wherein
prior to the step of initiating a virtual root node providing root domain name resolution service, the method further comprises:
determining whether the DNS resolution result is correct; and
if no, then initiating the virtual root node providing root domain name resolution service.

6. The method according to claim 5, wherein
the step of determining whether the DNS resolution result is correct comprises:
monitoring a DNS resolution message at the outlet of the backbone network within the predefined region;
determining whether the DNS resolution message is received and whether the DNS resolution message is matched with pre-stored results; and
if any one of results is determined to be negative, then determining that the resolution result of DNS is not correct.

7. A computing device for providing root domain name resolution service, comprising:
a memory having instructions stored thereon:
a processor configured to execute the instructions to perform operations for providing root domain name resolution service, the operations comprising:
acquiring, DNS resolution records of domain names within a predefined region; and
establishing an authorization information database of all-level nodes of DNS according to the resolution record, operating with a virtual root node providing the root domain name resolution service to respond to a root domain name resolution request within the predefined region according to data in the authorization information database.

8. The computing device according to claim 7, wherein
the operation of acquiring DNS resolution records of domain names within a predefined region further comprises: grabbing DNS resolution data packets at an outlet of backbone network within a predefined region; and analyzing the DNS resolution data packets to acquire all-level DNS resolution records of the resolved domain name.

9. The computing device according to claim 7, wherein
the operation of acquiring DNS resolution records of domain names within a vedefined region further comprises: in the process of domain name recursive resolution of a local recursive DNS, acquiring information of next level of authorization server in the all-level DNS authorization servers; and saving the acquired information of all-level authorization servers as the DNS resolution records of the domain names.

10. The computing device according to claim 7, wherein
the operations further comprise: saving the authorization information database in accordance with a type of domain name and to provide a data service in accordance with BGP.

11. The computing device according to claim 7, wherein the operations further comprise:
determining whether a resolution result of DNS is correct; and
in the case that the determining result of the DNS verification device is negative, initiating the virtual root node providing root domain name resolution service.

12. The computing device according to claim 11, wherein the operation of determining whether a resolution result of DNS is correct further comprises:
monitoring a DNS resolution message at the outlet of the backbone network within the predefined region;
determining whether the DNS resolution message is received and whether the DNS resolution message is matched with pre-stored results;
if any one of results is determined to be negative, then determining that the resolution result of DNS is not correct.

13. (canceled)

14. A non-transitory computer readable medium having computer programs stored thereon that, when executed by one or more processors of a computing device, cause the computing device to perform operations for providing root domain name resolution service, the operations comprising:
acquiring DNS resolution records of domain names within a predefined region;
establishing an authorization information database of all-level nodes of DNS according to the resolution record;
initiating a virtual root node providing root domain name resolution service; and responding to a root domain name resolution request within the predefined region according to data in the authorization information database by the virtual root node.

15. The non-transitory computer-readable medium according to claim 14, wherein the operation of acquiring DNS resolution records of domain names within a predefined region comprises:
grabbing DNS resolution data packets at an outlet of backbone network within a predefined region; and
analyzing the DNS resolution data packets to acquire all-level DNS resolution records of the resolved domain name.

16. The non-transitory computer-readable medium according to claim 14, wherein the operation of acquiring DNS resolution records of domain names within a predefined region comprises:
in the process of domain name recursive resolution of a local recursive DNS acquiring information of next level of authorization server in the all-level DNS authorization servers; and
saving the acquired information of all-level authorization. servers as the DNS resolution. records of the domain names.

17. The non-transitory computer-readable medium according to claim 14, wherein the operation of establishing an authorization information database of all-level nodes of DNS
saving the resolution records as the authorization information database in a distributed manner in accordance with a type of domain name wherein the authorization information database provides a data service in accordance with BGP.

18. The non-transitory computer-readable medium according to claim 14, wherein prior to the operation of initiating a virtual root node providing root domain name resolution
determining whether the DNS resolution result is correct; and
if no, then initiating the virtual root node providing root domain name resolution service.

19. The non-transitory computer-readable medium according to claim 18, wherein the operation of determining whether the DNS resolution result is correct comprises:
monitoring a DNS resolution message at the outlet of the backbone network within the predefined region;
determining whether the DNS resolution message is received and whether the DNS resolution message is matched with pre-stored results; and
if any one of results is determined to be negative, then determining that the resolution result of DNS is not correct.

20. The method according to claim 2, wherein
the step of establishing an authorization information database of all-level nodes of DNS according to the resolution record comprises:
saving the resolution records as the authorization information database in a distributed manner in accordance with a type of domain name Wherein the authorization information database provides a data service in accordance with BGP.

21. The method according to claim 2, wherein prior to the step of initiating a virtual root node providing root domain name resolution service, the method further comprises:
determining whether the DNS resolution result is correct; and
if no, then initiating the virtual root node providing root domain name resolution service.
